(19) United States
(12) Patent Application Publication
(10) Pub. No.: US 2015/0170206 A1
(43) Pub. Date: Jun. 18, 2015

(54) Advertisement Projector Device and Method for Bidding to Advertise with the Advertisement Projector Device

(71) Applicant: Orexin LLC, Hialeah, FL (US)

(72) Inventor: Omar Fagundo, Miami, FL (US)

(21) Appl. No.: 14/541,123

(22) Filed: Nov. 13, 2014

Related U.S. Application Data
(60) Provisional application No. 61/903,662, filed on Nov. 13, 2013.

(51) Int. Cl. G06Q 30/02; B61B 3/02; G03B 21/12

(52) U.S. Cl. CPC G06Q 30/0261; G06Q 30/0275; G03B 21/12; B61B 3/02

(57) ABSTRACT

A mobile projector device can move throughout a store, above the isles, and project advertisements for the goods in the store. The advertisements can be provided from remote sources. Advertisers can bid against each other for the use of the projector device. Inventory data, sales data, control sales data are provided to advertisers so they can make decisions on when to advertisement and how much to bid on advertising. Demographic data regarding customers at a location using the device (i.e. a store) are provided to the advertisers as well.

### CROSS-REFERENCE TO RELATED APPLICATIONS

This application claims the benefit of U.S. Provisional Application No. 61/903,662, filed Nov. 13, 2014, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to systems and methods for delivering advertising content to consumers, and in particular, to an automated mobile projector advertising system.

2. Description of the Related Art

Standardized advertisements are often ignored by sophisticated consumers who are accustomed to seeing the same advertisements over and over again. Advertisers need a new way to attract sophisticated consumers to learn about and purchase their product. The existing system is antiquated and ineffective at holding the attention of consumers.

To setup, modify, or change an advertisement at various locations, representatives must physically go to the location and change the advertisement. This is a time intensive and cost prohibitive way of advertising products to consumers. There is a need for a new way to attract the attention of consumers by delivering advertising content to consumers quickly, affordable, direct, and nationwide.

In the present advertising market, advertisers are limited in their ability to reach consumers at the point of purchase. Advertisers attract the attention of consumers using physical displays, coupon dispensers, floor adhesives, and television displays, to name a few. These advertising methods require an on-site human element, i.e., a representative of the advertising company to set up the displays and change them for various advertising campaigns. Every time a new advertising campaign is begun, a representative must remove the old display and set up the new display. This is a costly endeavor, especially when an advertising campaign occurs nationwide.

### BRIEF SUMMARY OF THE INVENTION

The invention encompasses a device for automated mobile projector advertising, including a track support system with a movable track carriage and a projector that displays an image on a surface.

An object of the invention is a system for automated mobile projector advertising, including loading advertising content onto a computer server on a computer network, clients at respective locations accessing the server via the network to download the advertisement, projecting the advertisement in close proximity to a consumer, capturing consumer data that is stored on a server on the network, and utilizing a managing tool to review the advertisement's success.

An object of the invention is to provide a device for displaying advertisements. The device includes a first rail aligned in a first lengthwise axis. A second rail travels along an axis of the first rail and extends at an angle to the first rail. A moveable track carriage travels along an axis of the second rail. The carriage carries a projector. The projector can be moved anywhere within a plane defined by the first and second rail by moving the second rail relative to the first rail and carriage relative to the second rail. A bus delivers power to the projector and to the motors of the carriage and the second rail.

In a retail store, the first rail is suspended from a ceiling of the store and runs parallel to the floor above the height of the shelves. The second rail is perpendicular to the first rail and also runs parallel to the floor above the shelves.

The projector displays advertisements onto a target surface. An example of a target surface is an area of the floor before a shelf containing a particular good. Another example of a target surface is an end of an isle containing a good being advertised.

The projector is connected to a computer network and receives media that is to be shown. The media can be still images, movies, and can include audio.

Another object of the invention is to provide a method for automated mobile projector advertising, including projecting advertising content for an advertised product when a consumer enters a location, capturing the consumer's reaction to the advertising content, and tracking whether the consumer purchased the advertised product after viewing the advertisement.

The present invention has the advantage of allowing advertisers to place the advertisement in close proximity to both the product being advertised and the consumer. Manufacturers pick a specific product they want to advertise and create an audio and/or visual advertisement for that product. The advertisement can air at various retail locations around the world. As long as the retail location is equipped with the present invention, an Internet connection, and the appropriate software, the advertiser can display the advertisement for a certain product across numerous locations directly to consumers.

Instead of a static display that most consumers ignore, the present invention provides a dynamic advertisement, i.e., video and/or audio, about a product directly to a consumer within reach of the product. This allows the advertiser to achieve a more personal connection with the consumer.

Connecting retail stores and locations across a nationwide network enables advertisers to quickly upload new advertisements through a network or server to the Internet. Within a short timespan, the advertisement is projected in a retail store in close proximity to the consumer that is contemplating purchasing the product next to them in the aisle.

Once the advertising campaign for a certain product has ended, the present invention is reconfigured for the next advertising campaign. A new advertisement is loaded onto the network and directed to the target retail locations.

The invention includes a computer network for sharing advertisement media, buying advertisements, and reporting advertisements. The network can include a computer that controls the device. The computer can send commands to move the projector to a desired location, aim the projector, and send media to be projected. The computer includes a connection to the computer network. In an advertisement database, the computer tracks the advertisements being displayed, the duration of time that the advertisements are displayed, and other data related to the store, customers, and advertisement consumption.

The store includes a computer that tracks inventory of goods and sales of goods. The computer reports the sales data and inventory data and relates the data to the advertisement data in the advertisement database.

A computer connected to the network is controlled by an advertiser. The advertiser can upload advertisement media that is to be projected in stores to a server.

An advertiser can bid to use the device to project advertisements based on market factors. Because the advertisement projector device is a limited asset (i.e. only one advertisement can be projected at one location at a given time), advertisers can bid to have their advertisement displayed. The advertiser with the highest bid will have its advertisement displayed. Advertisers with limited budgets can buy advertisement time at a discount in moments of less demand. For example, if the advertiser/wholesaler notices inventory accumulating in a retailer, the advertiser can bid to use the advertisement projector device to increase sales. If the advertiser knows that a store is more crowded with customers at a particular time, the advertiser can increase its bid to use the advertisement projector device to display its ads. If the advertiser knows of a particular circumstance, for example a weather emergency, the advertiser of goods for use in the emergency could increase its bid to use the projector device. Another example is that a wholesaler/advertiser of hot-dogs or hamburgers can increase its bid to advertise its hot dogs and hamburgers in a store that is near football stadium at a time preceding the football game. Demographics of shoppers and/or demographics of people living in neighborhoods surrounding a store can be shared with potential advertisers. Advertisers can increase bids to use the projector device in stores in which its target-demographic customers are shopping.

In accordance with a further object of the invention, the advertisement projector device can be located inside of a retail store or outside of the store.

Other features of the invention are set forth in the appended claims.

Although the invention is illustrated and described herein as embodied in an automated mobile projector for advertising, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a front view of an automated mobile projector advertising device according to the invention.

FIG. 2 is a system diagram according to the invention.

FIG. 3 is a step by step process flow of the method according to the invention.

FIG. 4 is a partial diagrammatic and partial schematic top side view of device according to the invention.

### DETAILED DESCRIPTION OF THE INVENTION

Embodiments of the invention are described below and are shown in the figures of the drawing. Unless otherwise mentioned the reference numbers are used consistently throughout the figures.

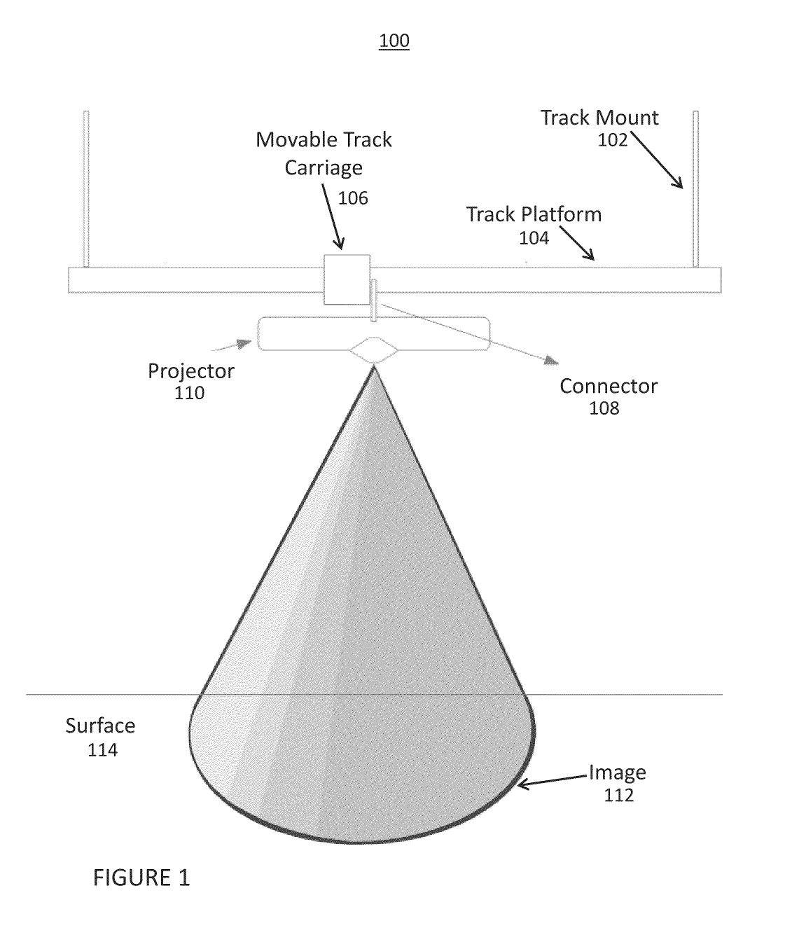

FIG. 1 shows device 100 for automated mobile projector advertising, including multiple track mounts 102. The upper portions of track mounts 102 are attached to a wall, e.g. a ceiling, to provide a stable anchor point for the present invention. Track mounts 102 hang from a wall in a substantially vertical position. Track platform 104 is connected to the lower portion of track mounts 102 and runs parallel from the ceiling. Track platform 104, in conjunction with track mounts 102 secured to the ceiling, provides a stationary base for movable track carriage 106 to travel along. The present invention uses a motor powered carriage that travels along track platform 104 attached to the ceiling of a retail store in between aisles. However, track carriage 106 can move along track platform 104 through a variety of mechanisms, including but not limited to, electric motors, rollers, and actuators.

Connector 108 attaches projector 110 to movable track carriage 106. Projector 110 moves along track platform 104 on movable track carriage 106. Projector 110 projects image 112, e.g., an advertisement, on surface 114 below projector 110. In an example embodiment, projector 110 emits an audio message to the consumer independent of, or in addition, to image 112.

In an example embodiment, shown in FIG. 1, a consumer walks down an aisle of a retail store. Close proximity, or the term near, is defined as within the audible and/or visual range of the consumer. A motion detector is preprogrammed with a specific distance or threshold from the product. Once the threshold is crossed, the motion detector triggers projector 110 positioned above the consumer on track platform 104. Projector 110 displays an advertisement, or image 112, on surface 114 next to the consumer.

In the preferred embodiment, movable track carriage 106 travels along track platform 104 moving projector 110 to the product for the next advertising campaign. The ease in moving projector 110 along the aisles of a retail store provides immense flexibility for advertisers to quickly switch from advertising one product to the next. By simply loading a new advertisement to server 214 over a network, e.g., an Internet connection, the next advertising campaign will start in a short time span. Moreover, the automated nature of the present invention eliminates the need for a representative to visit each individual retail location to change the advertisement. Once set up in the retail location, minimal maintenance is required. The present invention provides advertisers a nationwide communication system to affordably deliver timely advertising content through Internet integrated software.

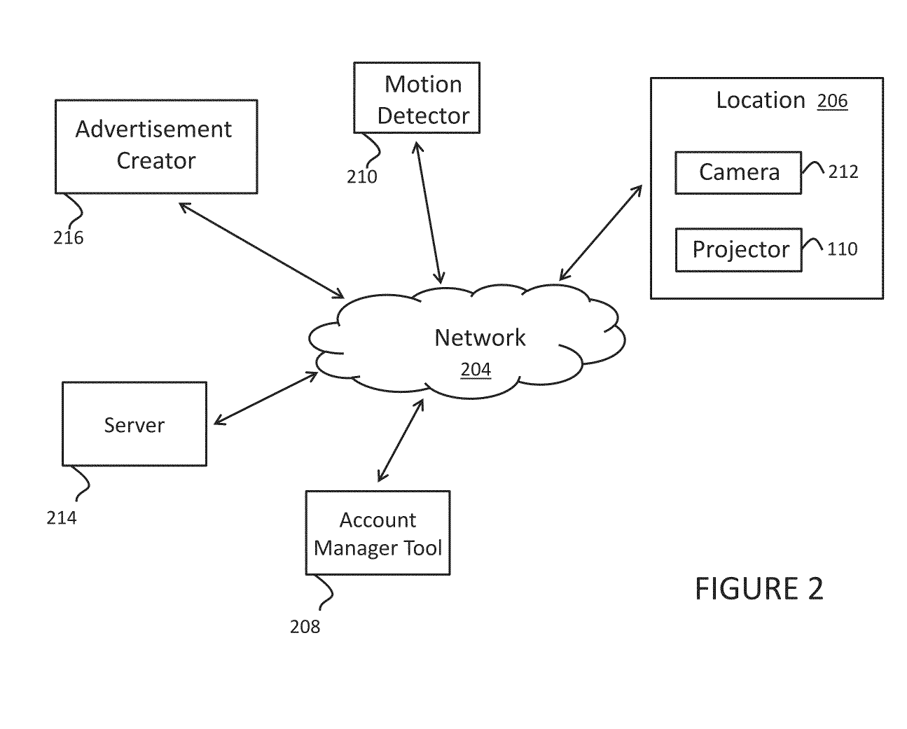

FIG. 2 illustrates a system for automated mobile projector advertising. Advertisement creator 216 prepares advertisement 202 to show to consumers. Advertisement creator 216 uploads advertisement 202 to server 214 via to network 204. Network 204 is accessible through a hard line or any Internet connection, such as, but not limited to, a personal computer, laptop, smart phone, or tablet. Using an Internet connection, advertisement creator 216 uploads new content for advertisement 202 for various advertising campaigns. This provides greater flexibility and reduced lead time to implement a new advertising campaign.

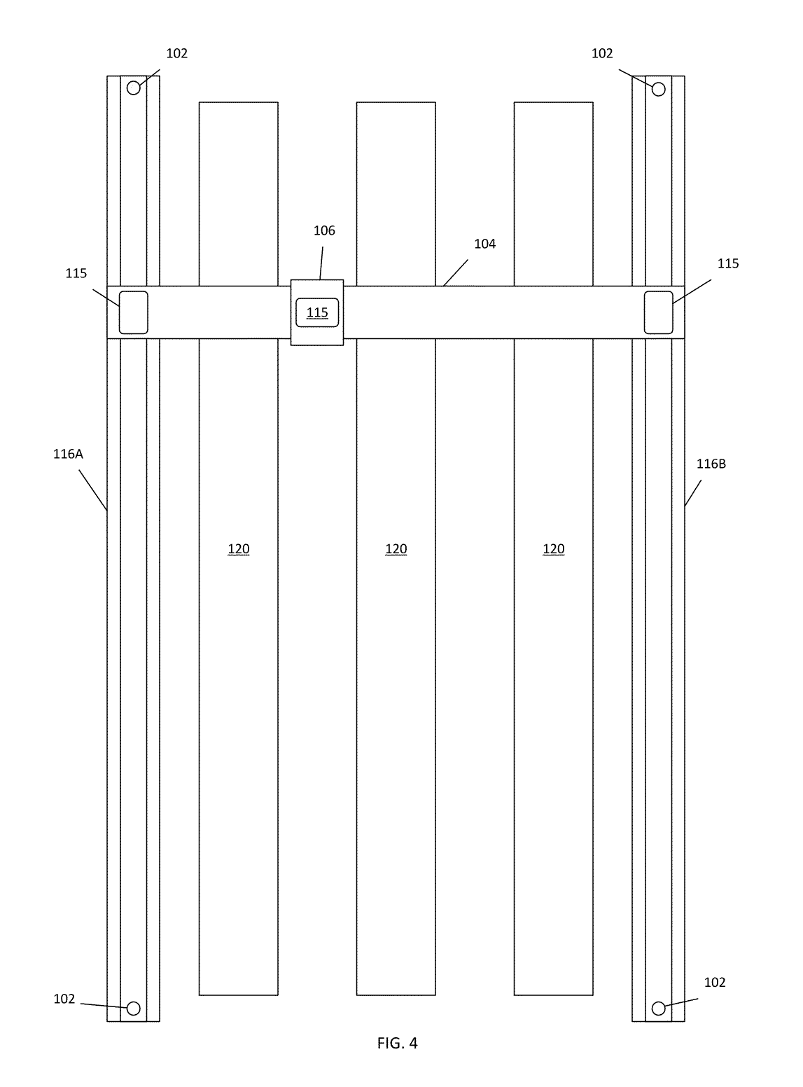

In a preferred embodiment of a method of buying in-store advertising, the device 100 shown in FIGS. 1 and 4 is connected to the computer network shown in FIG. 2. Advertisers 216 use a computer connected to the network to bid on using an advertisement projector device 100 in a given store to display their advertisement. An account of an advertiser bidding the highest amount is charged and the advertiser's advertisement is shown.

To influence potential advertisers, a server can provide inventory data regarding a wholesalers/advertisers products. Likewise, sales data following the projecting of an advertisement in a store can be supplied to the advertiser via the computer network. Demographic information for a store's customers and for customer living in the surround neighborhood is preferably included in a database, which can be searched by potential advertisers.

Advertisement creator 216 selects the specific retail locations 206 where advertisement 202 is displayed. Based on the various retail locations equipped with the present invention, the advertiser selects which locations 206 to air advertisement 202 using account managing tool 208. Advertisement 202 is initialized through account managing tool 208 and sent to the selected retail locations over network 204 for locations 206 equipped with the system.

In location 206, the movement of a nearby consumer triggers motion detector 210, which causes projector 110 to start advertisement 202. Advertisement 202 is projected from the ceiling, above the consumer, onto surface 114 in close proximity to the consumer and the advertised product. Positioning advertisements 202 in close proximity to the advertised product allows the consumer to take the product off the shelf immediately after witnessing advertisement 202.

Sales of the product featured in advertisement 202 are tracked at the point-of-sale (“POS”). This enables advertisement creator 216 to determine the quantity of purchased products at location 206 displaying advertisement 202. Correlating UPC codes of the company and product enables advertisement creator 216 to determine the effectiveness of the advertising campaign.

Cameras 212 at location 206 capture the consumer response to advertisement 202. The cameras are positioned close enough to determine whether the consumer ignored advertisement 202 or took the product from the shelf for purchase. Account managing tool 208 analyzes the consumer reaction data and compiles the information. This data is sent to network 204. The data from camera 212 remains on network 204 for a limited time and is then purged due to privacy concerns. In an example embodiment, account managing tool 208 is located on network 204.

Advertisement creator 216 manages the advertising account over network 204, in conjunction with account managing tool 208. This includes, but is not limited to, scheduling the advertisement, selecting locations 206 to air advertisement 202, calculating how many times the advertisement aired based on traffic flow, reviewing camera 212 footage data to determine the effectiveness of the advertisement at the various locations advertisement 202 aired, and correlating POS data with advertisement 202. Instead of having a static advertisement with no indication of the advertisements' direct impact on consumers, the present invention provides essential data to advertisers to determine the effectiveness of advertisement 202 on the consumer.

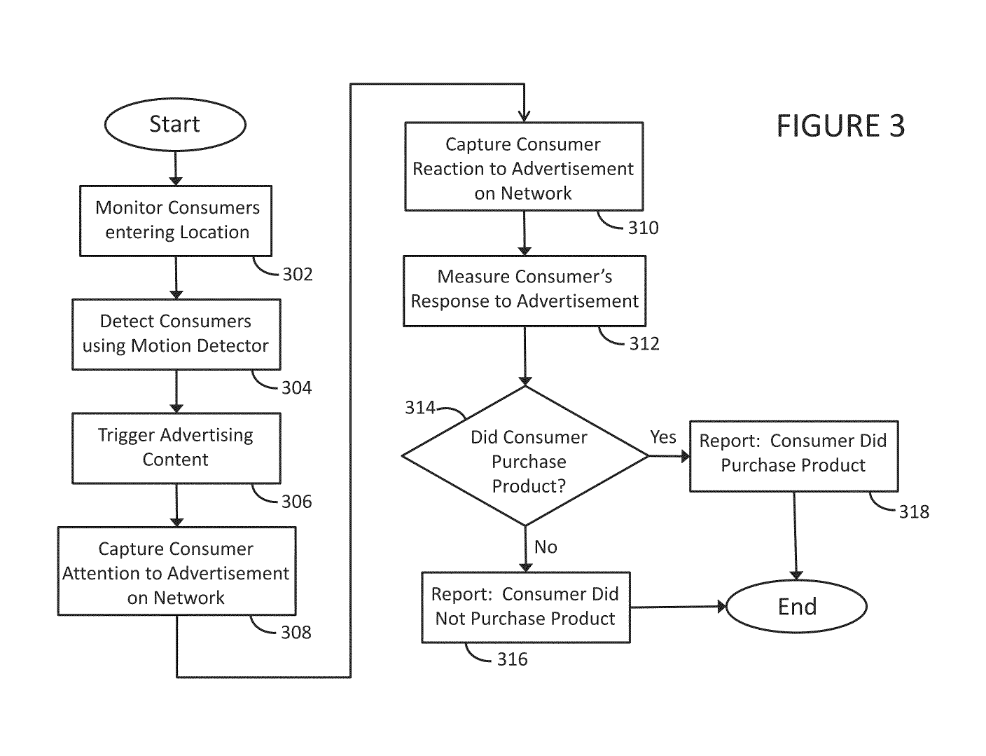

FIG. 3 shows a method of the automated mobile projector advertising invention. A consumer enters a retail location and approaches the advertisement viewing area, Step 302. As the consumer approaches, motion detector 210 recognizes the presence of the consumer in the advertising area, Step 304, and triggers advertisement 202 to start, Step 306. Advertisement 202 is projected from projector 110 located above the consumer onto surface 114. In an example embodiment, surface 114 is the floor underneath projector 110.

As advertisement 202 is played to the consumer, nearby cameras 212 record the reaction of the consumer to the advertisement and store the data on network 204, Step 308. Advertisement creators 216 want to know whether the consumer ignores advertisement 202 or if they listen to and watch the content of the advertisement. This is important data to report back to the manufacturer or client who commissioned advertisement 202. In Step 310, the consumer's reaction is recorded by nearby cameras 212 and stored on network 204. It is important for advertisers to measure the consumer's response to advertisement 202 to determine the impact of the advertisement on the consumer, Step 312. The advertiser determines whether the consumer purchased the product in Step 314. In Step 316, the consumer does not purchase the product described in the advertisement. In Step 318, the consumer does purchase the product described in the advertisement.

FIG. 4 shows a preferred embodiment of an advertisement projector device 100. The device 100 includes a first rail 116A suspended from a ceiling of a store by track mounts 102. A second rail 116B is suspended from the ceiling of the store by track mounts 102. The first rail 116A and second rail 116B are parallel to each other. A track 104 spans the first rail 116A and the second rail 116B. The track 104 travels along the length of rails 116A and 116B. Motors 115 on the rails 116A and 116B drive wheels, which are not shown, on the track 104 and 104B to move the track 104A along the rails 116A and 116B. The movable track carriage 106 moves along an axis of the track 104. A motor 115 on the track carriage moves the track carriage 106 along the track 104. The projector 110 is not shown but is on the underside of the track carriage 106. The track carriage 106 moves to locations in the store to project advertisements on the floor between the isles 120 of goods.

Although the invention is detailed by the embodiments, illustrations, and examples, the scope of the invention should not be limited to those embodiments, illustrations, and examples.

What is claimed is:

1. A device for promoting two goods, comprising:
a track having a length and a first location and a second location along said length, said first location being proximate a first good and said second location being proximate a second good;
a track carriage being configured to travel along said length of said track; and
a projector being disposed on said track carriage, said projector being configured to project a first advertisement promoting the first good when said track carriage is located at said first location and to project a second advertisement promoting the second good when said track carriage is located at said second location.

2. The device according to claim 1, further comprising a further rail being connected to said rail, said further rail being disposed at an angle to said rail, said rail being configured to travel along said further rail.

3. The device according to claim 2, further comprising a second further rail being connected to said rail, said second further rail being aligned parallel to said further rail, said rail being configured to travel along said second further rail when traveling along said further rail.

4. The device according to claim 1, further comprising a network interface controller connected to said projector, said network interface controller being configured to receive an instruction to move said track carriage to said first location and to receive an instruction to move said track carriage to said second location.

5. The device according to claim 1, further comprising a network interface controller connected to said projector said network interface controller being configured to receive the first advertisement to be projected and to receive the second advertisement to be projected.

6. The device according to claim 5, further comprising a computer server, said computer server being connected to said network interface controller, said computer server storing the first advertisement and the second advertisement, said computer server transmitting the first advertisement to said network interface controller when the first advertisement is to be projected, and said computer server transmitting the second advertisement to said network interface controller when the second advertisement is to be projected.

7. The device according to claim 1, further comprising:
a first motion detector connected to said projector, said first motion detector signaling said projector to display the first advertisement when a customer is at the first location; and
a second motion detector connected to said projector, said second motion detector signaling said projector to display the second advertisement when a customer is at the second location.

8. The device according to claim 1, further comprising a computer server connected to an inventory database, the inventory database tracking sales of the first good, said computer server relating the sales of the first good to the projecting of the first advertisement for the first good.

9. The device according to claim 1, further comprising a computer server connected to an inventory database, the inventory database tracking inventory of the first good; said computer server transmitting the inventory of the first good to an advertiser.

10. A method for offering to advertise two goods, which comprises:
providing a projector, said projector being configured to project a first advertisement promoting a first good and being configured to project a second advertisement promoting a second good; and
projecting said first advertisement when an advertiser of said first good bids more than an advertiser of said second good.

11. The method according to claim 10, which further comprises:
moving said projector more proximate to said first good when said advertiser of said first good bids more than said advertiser of said second good; and
moving said projector more proximate to said second good when said advertiser of said second good bids more than said advertiser of said first good.

12. The method according to claim 10, which further comprises:
monitoring a consumer entering into a location;
detecting the consumer approaching the first good using a motion detector; and
projecting said first advertisement for said first good when the consumer is detected by said motion detector.

13. The method according to claim 10, which further comprises calculating sales of the first good when the advertisement is projected.

14. The method according to claim 13, which further comprises calculating sales of the first good when the advertisement is not projected.

15. The method according to claim 10, which further comprises transmitting an inventory of the first good to the advertiser.

16. The method according to claim 10, which further comprises transmitting data regarding customers to the advertiser of the first good.
